(19) United States
(12) Patent Application Publication
(10) Pub. No.: US 2010/0305784 A1
(43) Pub. Date: Dec. 2, 2010

(54) Embedded Ground Proximity Warning System for Helicopters

(76) Inventors: Thomas E. Anderson, California, MD (US); Thomas D. Anderson, Port Republic, MD (US)

Correspondence Address: Department of the Navy;(Naval Air Warfare Center -Aircraft Division), 47076 Lijencreantz Road, B 435, PATUXENT RIVER, MD, 20670, US

(21) Appl. No.: 12/471,607

(22) Filed: May 26, 2009

(51) Int. Cl. G05D 1/00; G01C 5/00

(52) U.S. Cl. 701/9

(57) ABSTRACT

A system for warning a pilot of a helicopter of a flight-into-terrain hazard includes a signal processing component that determines helicopter flight conditions by fusing data obtained from multiple flight condition data sources, a protection component that communicates with the signal processing component, determines whether a potential controlled flight-into-terrain hazard exists by computing predicted recovery trajectories based upon flight conditions and characteristics of the helicopter and decides upon a recovery trajectory, and a pilot interface component that provides a directive to the pilot to indicate the decided-upon recovery trajectory if multiple predicted recovery trajectories indicate a terrain impact will occur.

### GOVERNMENT INTEREST

The invention described herein may be manufactured, licensed, and used by or for the U.S. Government.

### BACKGROUND

Perhaps the most distressing air accidents are those in which a fully functioning aircraft is flown under control of the pilot into the ground. In recent years, there has been a disturbing increase in rotary wing Controlled Flight Into Terrain (CFIT) accidents. Conventional Ground Proximity Warning Systems (GPWS) and Terrain Awareness Warning Systems (eTAWS) for rotary wing aircraft either fail to provide adequate warnings in time for pilots to take evasive action or provide so many false or “nuisance” warnings that their usefulness is impaired especially for military tactical applications. Thus, there is an immediate need for an effective warning system to avoid CFIT accidents in helicopters.

U.S. Pat. No. 6,484,072, issued on Nov. 19, 2002 to Anderson et al. (the “'072 patent”), incorporated by reference herein as if fully set forth, discloses an embedded Terrain Awareness Warning System (eTAWS) for non-rotary winged aircraft. The eTAWS system described in the '072 patent computes vertical and oblique flight trajectories and alerts the pilot only when both of the solutions indicate that a CFIT danger exists. The system of the '072 patent warns the pilot in time to take evasive action and does not issue excessive nuisance warnings. The maneuvering capabilities of a rotary-wing aircraft such as a helicopter are quite different from those of a fixed-wing aircraft. Most notably, helicopters are able to hover. Thus, while the physical principles governing flight still apply, the manner of control, power and, consequently, the mathematical models of rotary-wing aircraft motion during recovery to avoid controlled flight into terrain are significantly different from those for fixed-wing aircraft. The system of the '072 patent also includes a digital terrain elevation database from which it takes input to determine local terrain. In a number of applications a digital terrain elevation database is not practical. Embodiments according to the present invention are directed to methods and apparatuses for a GPWS system for rotary-wing aircraft.

### SUMMARY

In general, in one aspect, an embodiment of a system for warning a helicopter pilot of a flight-into-terrain hazard includes a signal processing component that determines helicopter flight conditions by fusing data obtained from multiple flight condition data sources, a protection component that communicates with the signal processing component, determines whether a potential controlled flight-into-terrain hazard exists by computing predicted recovery trajectories based upon flight conditions and characteristics of the helicopter and decides upon a recovery trajectory, and a pilot interface component that provides a directive warning to the pilot to indicate the decided-upon recovery trajectory if multiple predicted recovery trajectories indicate a terrain impact will occur.

### BRIEF DESCRIPTION OF THE DRAWINGS

Exemplary embodiments according to the invention are illustrated in the accompanying drawings in which like reference numerals represent like parts throughout and in which:

FIG. 1 is a simplified block diagram of an embodiment of a ground proximity warning system according to the present invention;

FIG. 2 is a representation of the predicted recovery trajectories used to determine when a controlled flight into terrain situation exists;

FIG. 3 is a representation of a visual display of aircraft pitch and roll attitudes in respect to an artificial horizon and on which is also provided a display arrow showing a direction for recovery (pull up is required in this case) when a warning condition has been computed in an embodiment according to the present invention; and

FIG. 4 is a representation of a visual display of aircraft pitch and roll attitudes in respect to an artificial horizon and on which is also provided a display arrow showing a direction for recovery (roll left is required in this case) when a warning condition has been computed in an embodiment according to the present invention.

### DETAILED DESCRIPTION

In the following detailed description, reference is made to the accompanying drawings which are a part of this patent disclosure, and in which are shown by way of illustration specific embodiments in which the invention, as claimed, may be practiced. This invention may, however, be embodied in many different forms and should not be construed as limited to the embodiments set forth; rather, these embodiments are provided so that this disclosure will be thorough and complete, and will fully convey the scope of the invention to those skilled in the art.

The helicopter provides a complex vibratory environment. Vibrations emanate from many different sources including the main rotor, the tail rotor, gearboxes, linkages and engines. Vibrations vary in intensity and frequency depending on the speeds and relative speeds of rotation of the main and tail rotors, load factors, structural deformation, resonances inherent in the airframe, and aerodynamic forces. Embodiments of a GPWS rely, at least in part, on accelerations sensed by the Inertial Navigation System (INS). However, due to the helicopter's intense vibrations, the INS sensed accelerations are very noisy, which results in erroneous predictions. To mitigate the effects of the vibrations, advanced filtering techniques are employed, as described below. Modeling of the multiple recovery trajectories, advanced sensor techniques, and flight phase determinations are among the significant differences between embodiments according to the present invention and the invention described in the '072 patent.

Embodiments of a GPWS according to the present invention may be implemented on a variety of airborne computer platforms including without limitation, a personal computer, a flight computer, a navigational/mapping computer, or another onboard flight-worthy computer system. For example, the Flight Management Computer on an MH-60 helicopter and the mission computer on an H-1 are both suitable platforms for implementing embodiments of a GPWS according to the present invention. An I/O interface is created for each aircraft on which the system is implemented.

The system makes use of multiple helicopter sensors to derive a variety of input parameters indicative of flight conditions, as described in more detail below. While dedicated sensors may be used in some embodiments, the system preferably relies upon sensory data that is already available. GPWS is designed to provide protection against Controlled Flight Into Terrain (CFIT) by computing alternative predicted recovery trajectories based upon current flight conditions to determine the altitude required for recovery from the flight path of the helicopter, and comparing that altitude to the computed height above the terrain. The solutions may be derived using inputs from a variety of onboard systems and sensors, as described in greater detail, below.

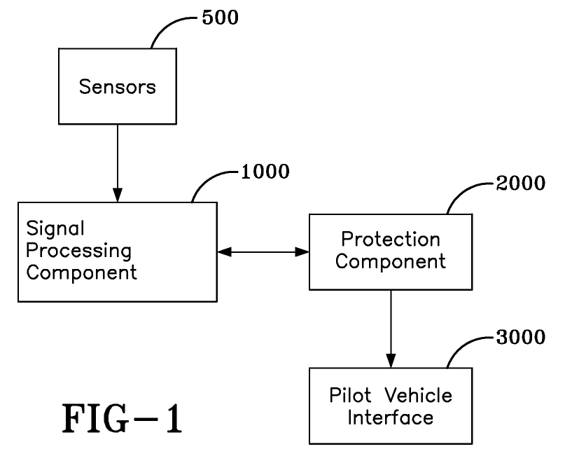

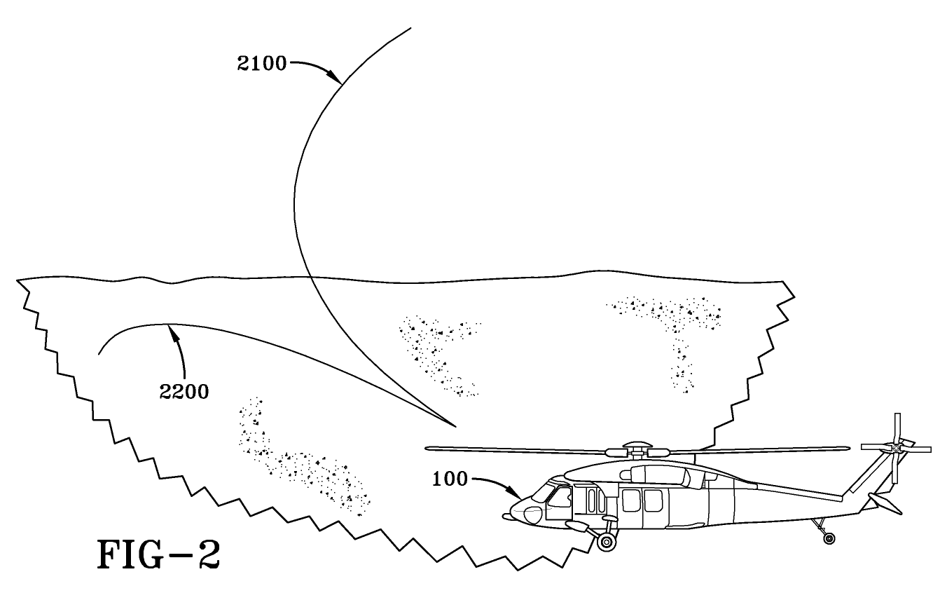

The preferred embodiment of the present invention is illustrated by way of example below and in FIGS. 1, 2, 3, and 4. As seen in FIG. 1, a GPWS for a helicopter 100 includes a signal processing component 1000, a protection component 2000, and a pilot interface 3000. Although the system according to the invention is illustrated as a series of functional blocks for purposes of clarity, it is to be understood that the actual implementation of the system may be other than specifically shown in FIG. 1, with various digital and analog implementations being possible.

The signal processing component 1000 determines helicopter flight conditions, including but not limited to, current height above terrain, velocity, acceleration, terrain slope, and aircraft attitude by fusing data obtained from a variety of inputs including aircraft sensors, flight instruments, engine instruments, flight computers, navigational computers, air data computers, and the like, collectively referred to as flight condition data sources 500. The use of multiple flight condition data sources 500 allows signal processing component 1000 to accurately determine flight condition data even when some sensors are unavailable and also allows rejection of spurious data. Examples of flight condition data sources 500 include, but without limitation, a radar altimeter, a vertical velocity sensor, a vertical gyro, a barometric altimeter, a weight on wheels sensor, a torque sensor, or any other type of sensor or system that gathers, monitors, reports, calculates, conveys or collects any type of helicopter data or helicopter parameters. Aircraft flight condition data 500 may also be obtained from a digital data bus in certain newer aircraft. Signal processing component 1000 may also obtain aircraft flight condition data 500 from on board flight computers and navigational systems. For example, signal processing component 1000 may obtain aircraft flight condition data from an air data computer (the air data computer typically measures the speed of helicopter 100 relative to the surrounding air mass and atmospheric conditions indicating altitude), an Inertial Navigation System (this system measures linear and angular accelerations and computes the linear and angular positions and velocities of the aircraft relative to the earth), a Global Positioning System (GPS), and numerous helicopter-specific inputs (e.g., but without limitation, landing gear position, gross weight, and data validity indicators), as may be present on helicopter 100. Of considerable advantage in aircraft environments, embodiments of a GPWS according to the present invention may be implemented without increasing system size, weight and power requirements. In today's military platforms, reducing system size, weight, and power (SWaP) is critical to meet operational life and budgetary constraints.

Terrain slope is one parameter that is used to indicate the characteristic of the terrain. In the case of rotary wing aircraft, a one second moving average of altitude data is used to derive the terrain slope. Helicopters are highly maneuverable and may enter conditions where the radar altimeter is no longer providing height above terrain information. In this condition, the GPWS estimates the height above the terrain based on the last measured terrain height (the difference between mean sea-level and radar altitude measurements) and the change in the mean sea-level altitude. However, if the aircraft is over varying terrain, the last measured terrain height will be erroneous. To avoid this problem, GPWS only estimates the height above terrain when the terrain slope indicates that the terrain is substantially level (e.g., in this embodiment, the magnitude of the slope is less than two degrees). For conditions where the terrain is varying and radar altimeter data is not reliable, GPWS uses the measured mean sea-level altitude (from a barometric pressure altimeter and/or GPS data) as the height above terrain because there is presently no reliable means of determining the terrain height.

Protection component 2000 communicates with signal processing component 1000 such that the protection component 2000 is able to determine if a potential controlled flight into terrain situation exists. Protection component 2000 predicts the flight path of helicopter 100, determines the altitude required for recovery from the trajectory, and compares it to the height above terrain from the signal processing component 1000 to determine if a warning condition exists.

Protection component 2000 preferably predicts two recovery trajectories: a vertical recovery trajectory (VRT) and an oblique recovery trajectory (ORT). The recovery trajectories are specifically tailored to the current flight conditions (for example, winds, density altitude, ambient temperature, altitude) as well as to the characteristics of the helicopter including, but not limited to, performance, control, and flight characteristics. The VRT assumes that the helicopter will be rolled to a near-zero bank angle followed by the addition of collective and/or aft cyclic to achieve a target normal acceleration until the recovery is complete. The oblique recovery trajectory (ORT) assumes that a current bank angle will be maintained during recovery and that increasing collective and/or aft cyclic will be applied to achieve the target normal acceleration until the recovery is complete. Multiple recovery trajectories (in this example, both the VRT and the ORT) must indicate terrain impact would occur before a warning is issued to the pilot. The use of multiple recovery trajectories that match the capabilities and characteristics of rotary-wing aircraft and prevailing flight conditions significantly reduces the probability that nuisance warnings will be issued. While more than two recovery trajectories could be employed in alternative embodiments, use of the VRT together with the ORT has yielded successful results and is preferred, particularly in embodiments according to the present invention, which do not include a digital terrain elevation database.

Predicted recovery trajectories are broken down into four components: a pilot response phase, a roll response phase, a g-onset phase, and a dive recovery phase. In the system described in the '072 patent, a fifth phase—a “g-delay” phase, is used. This phase does not physically apply to rotary-wing flight and is therefore not used in embodiments according to the present invention.

### Pilot Response Phase

The pilot response phase of a predicted recovery trajectory takes place in a period during which certain flight conditions may be presumed to exist without any pilot intervention. The time period of the pilot response phase is determined by the amount of time, on average, required for a pilot to respond to visual and aural cues provided by the GPWS system and initiate a responsive action. In tests of a prototype GPWS according to the present invention an optimal pilot response time was determined to be 1.3 seconds. This time is sufficient to account for the pilot being situationally unaware. During the pilot response phase, changes in flight conditions are predicted based upon the current rotary wing aircraft velocities and accelerations. The prediction computes the position, velocity, acceleration, and attitude of the helicopter at the end of the pilot response phase. Average values are used to explicitly define the flight path during the phase (instead of iteratively).

### Roll Response Phase

The roll response phase only applies to the VRT because the ORT assumes that the recovery will occur at a predicted bank angle determined in the pilot response phase. When the predicted bank angle at the end of the pilot response phase is greater than 30 degrees, the helicopter must first roll to near zero degrees bank angle with respect to the horizon (i.e., “wings level”) to ensure that the lift vector is indeed pointing away from the terrain. The time required to roll to wings level (when required) is flight condition and helicopter dependent and is computed as part of the prediction. As before, the prediction computes the position, velocity, acceleration, and attitude of the helicopter at the end of the roll response phase.

In a fixed-wing aircraft, when the pilot pulls back on the stick there is a momentary delay or “g-delay phase” as the tail deflects downward and there is a resulting loss of lift under the wings. There is no g-delay phase for a helicopter, thus, no g-delay phase is provided in embodiments according to the present invention.

### g-Onset Phase

The third phase applicable to rotary-wing aircraft is the g-onset phase. During this phase the helicopter's normal acceleration (nominally, one g) increases to a target normal acceleration for recovery based upon the force available from the rotor system for the current flight condition. In the g-onset phase, the pilot applies aft cyclic or increased collective to affect this increase in normal acceleration. This phase ends when the normal acceleration reaches the target normal acceleration for recovery. The target normal acceleration for recovery is flight condition (e.g., density altitude, aircraft load) and helicopter dependent and is predicted from the modeled thrust available from the rotor system and the rate at which it can be applied. Position, velocity, acceleration, and attitude are predicted for the end of this phase. In contrast to fixed-wing applications, the rotary-wing recovery is based solely on the power available from the engine(s) via the rotor system.

### Dive Recovery Phase

The dive recovery phase is the final component of the recovery trajectories. In this phase the helicopter maintains the target normal acceleration until the recovery is complete. In contrast to fixed-wing systems described in the '072 patent, which model the recovery trajectory as an ellipse in order to account for both increases in airspeed and target normal acceleration (due to the increased airspeed), embodiments according to the present invention account for the addition of collective (rotor force) only in this phase. This difference significantly changes the predicted recovery trajectory. In the preferred embodiment, the dive recovery phase trajectory has been modeled as an extended parabola.

### Low Speed Conditions

GPWS systems for helicopters according to the invention must also intelligently determine the pilot's intentions in low speed conditions. Unlike GPWS systems for fixed-wing aircraft, which assume a landing is intended when the landing gear is down and the aircraft is operated in a low-speed environment, helicopters regularly operate in low-speed and hover conditions without intending to land (i.e., vertical replenishment, search-and-rescue operations) and frequently will have fixed landing gear or skids. Embodiments according to the present invention account for such circumstances to avoid nuisance warnings. For example, for helicopters operating onboard a ship, a GPWS system according to the present invention may be configured to account for a change in pilot intentions from when the helicopter operates over the deck of a vessel versus when the helicopter is over the water. As the helicopter lifts-off from the deck of a vessel and flies away, GPWS senses the deck-edge crossing, i.e., the transition from being over the ship to being over water, by monitoring the change in computed terrain height from signal processing component 1000, and presumes that once the helicopter is over the water (terrain height has rapidly dropped), landing is not desired for 30 seconds, regardless of airspeed. This ensures that GPWS will provide a warning such that the helicopter can be recovered without hitting the water—that is, there is no intention to land in the water. While 30 seconds has been used in the preferred embodiment according to the present invention, other time periods may be used in alternative embodiments. In all other low-speed conditions, GPWS will assume that there is intent to land and simply protect against hard-landings. Hard landings are landings where the sink rate at touchdown is predicted to exceed the structural limit of the landing gear.

### Rotary-Wing Signal Processing

As noted above, the high noise environment of a rotary-wing aircraft causes special problems for a GPWS. In the MH-60, for example, the Embedded GPS Inertial system (EGI) is located in the nose of the aircraft which exacerbates the acceleration noise problems. To mitigate these problems, the first derivative of inertial velocities is computed and used as the accelerations throughout the system.

### Operation

Operation of an embodiment of the present invention will now be described. In general, an embodiment of a GPWS system calculates vertical and oblique three-dimensional recovery trajectories and compares the altitude projection of these trajectories to the computed height above the terrain to determine if a warning is necessary. The system operates continuously while the helicopter is in flight and provides a rapid sequence of updated recovery trajectories so that sufficient warning is provided to the pilot whenever current flight conditions indicate that a safe altitude above terrain may not be maintained.

The protection component 2000 computes the altitude required to recover, as stated above, with reference to altitude projections based on radar altimeter data. The radar altimeter provides above ground altitude and basic terrain slope data. Protection component 2000 determines how much altitude would be required for a recovery for the three-dimensional recovery trajectories and determines an ending point for the recovery based on the altitude at which the helicopter flight path is parallel to the terrain (for level and descending terrain as determined by the terrain slope in signal processing component 1000). For a landing condition, the ending point of the recovery is when the predicted downward velocity equals the landing gear structural limit. When the recovery achieves the targeted downward velocity, the recovery is complete. The altitude between the initial altitude and the altitude at which the targeted downward velocity is achieved is the altitude required to recover. When altitude required to recover is greater than or equal to the height above the terrain, as computed by the signal processing component 1000, for 4 consecutive frames or iterations, the protection component 2000 sets the warning which is communicated to the pilot interface component 3000.

When a warning condition is computed by protection component 2000, the pilot interface component 3000 acts as follows. A determination is made as to which directive warning should be given to the pilot. This determination is based on which of the recovery trajectories is the last to indicate terrain impact. If the ORT is the last to indicate terrain impact, the pilot directive warning will be to pull up or add power based on airspeed, pitch angle, and torque. If the VRT is the last to indicate terrain impact, the pilot directive warning will be to roll left or roll right, as appropriate if the bank angle is greater than 30 degrees. If the bank angle is less than 30 degrees, the directive will be to add power or pull up, based on pitch angle, airspeed and torque.

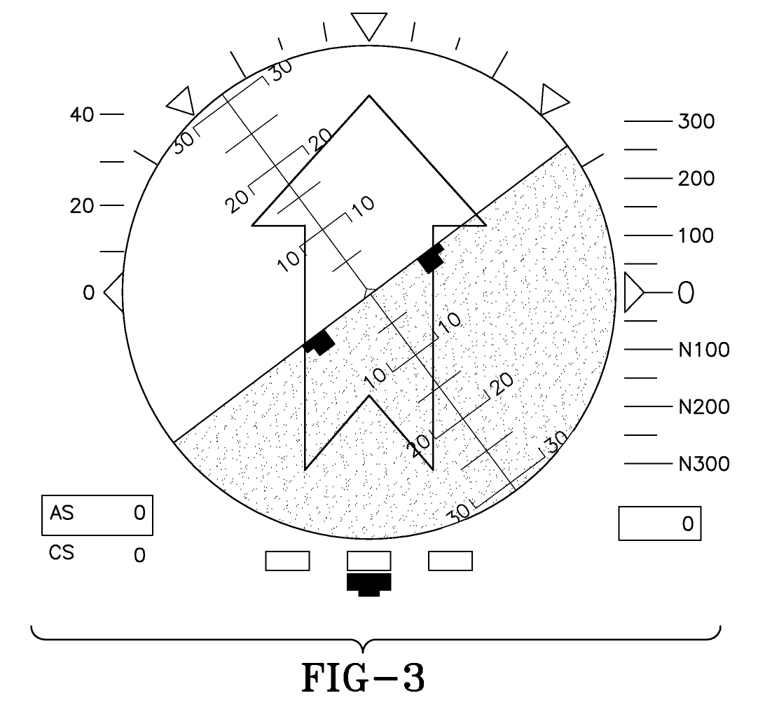

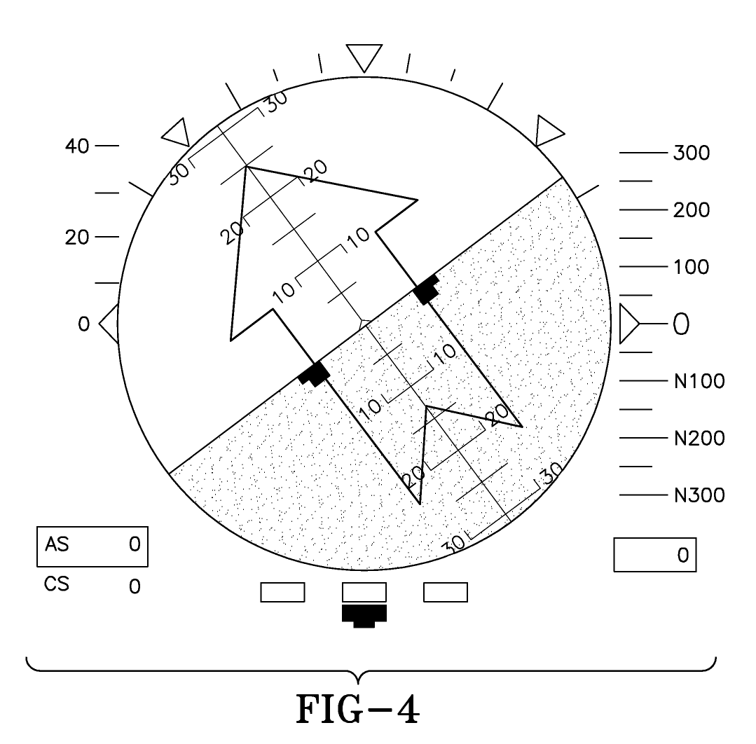

Pilot interface component 3000 provides directive aural cues via the headset to the pilot(s). At the same time, a directive visual cue is provided to the pilot on a primary flight display, if so enabled on the particular aircraft. In this example, an arrow is displayed on an attitude indicator 300 which points in the direction for recovery see FIG. 3 and FIG. 4. Other displays, primary or secondary, may similarly be used in alternative embodiments, for example, a horizontal situation indicator, an artificial horizon, a head-up display, a computer generated artificial terrain, and/or a display dedicated to providing directive visual cues for a GPWS system according to the present invention. The preferred directive aural cues are: “Pull-Up . . . Pull-Up”, “Roll-Left . . . Roll-Left”, “Roll-Right . . . Roll-Right”, “Power . . . Power”. Other aural, visual and sensory cues and indications may be provided in alternative embodiments. Aural cues have been determined experimentally to be most effective and are the primary means of alerting the pilot to an impending controlled flight into terrain situation. The directive nature of the aural cues requires little thought thus minimizing the pilot response delay. Visual cues will generally be secondary since they require the pilot to already be looking at the display.

### Conclusion

Although the present invention has been described in considerable detail with reference to certain embodiments hereof, it will be clear to one skilled in the art that the above embodiments may be altered in many ways without departing from the invention. Accordingly, the spirit and scope of the appended claims should not be limited to the description of the embodiments contained herein.

What is claimed is:

1. A system for warning a pilot of a helicopter of a flight-into-terrain hazard, comprising:
a signal processing component that determines helicopter flight conditions by fusing data obtained from multiple flight condition data sources;
a protection component that communicates with the signal processing component, determines whether a potential controlled flight-into-terrain hazard exists by computing predicted recovery trajectories based upon flight conditions and performance characteristics of the helicopter and decides upon a recovery trajectory; and
a pilot interface component that provides a directive to the pilot to indicate the decided-upon recovery trajectory if multiple predicted recovery trajectories indicate a terrain impact will occur.

2. The system for warning a pilot of a helicopter of a flight-into-terrain hazard according to claim 1, wherein the predicted recovery trajectories comprise a vertical recovery trajectory and an oblique recovery trajectory.

3. The system for warning a pilot of a helicopter of a flight-into-terrain hazard according to claim 2, wherein the predicted recovery trajectories comprise a pilot response phase, a g-onset phase, and a dive recovery phase.

4. The system for warning a pilot of a helicopter of a flight into terrain hazard according to claim 3, wherein the pilot response phase comprises the amount of time, on average, required for a pilot to respond to cues to initiate a responsive action.

5. The system for warning a pilot of a helicopter of a flight-into-terrain hazard according to claim 4, wherein the amount of time for the pilot response phase comprises about 1.3 seconds.

6. The system for warning a pilot of a helicopter of a flight-into-terrain hazard according to claim 3, wherein the vertical recovery trajectory further comprises a roll response phase to account for the time it takes to roll to an approximately zero degree bank angle.

7. The system for warning a pilot of a helicopter of a flight-into-terrain hazard according to claim 4, wherein the g-onset phase accounts for the time it takes the helicopter to achieve a target normal acceleration for recovery.

8. The system for warning a pilot of a helicopter of a flight-into-terrain hazard according to claim 7, wherein the target normal acceleration for recovery is flight condition and helicopter dependent.

9. The system for warning a pilot of a helicopter of a flight-into-terrain hazard according to claim 7, wherein the dive recovery phase accounts for the time it takes for the helicopter to complete the recovery at the target normal acceleration after achieving the target normal acceleration.

10. The system for warning a pilot of a helicopter of a flight-into-terrain hazard according to claim 1, wherein the flight conditions of the helicopter upon which predicted recovery trajectories are based comprise the conditions of transitioning from being over a vessel to being over water.

11. The system for warning a pilot of a helicopter of a flight-into-terrain hazard according to claim 10, wherein the system presumes that a landing is not desired for a predetermined period, regardless of airspeed, when the flight condition of the helicopter has transitioned to be over water.
